(19) United States
(12) Patent Application Publication
(10) Pub. No.: US 2020/0094421 A1
(43) Pub. Date: Mar. 26, 2020

(54) ROBOT UNIT

(71) Applicant: OKUMA Corporation, Niwa-gun (JP)

(72) Inventor: Shoichi MORIMURA, Niwa-gun (JP)

(21) Appl. No.: 16/571,584

(22) Filed: Sep. 16, 2019

(30) Foreign Application Priority Data
Sep. 21, 2018 (JP) 2018-177807

(51) Int. Cl. B25J 17/00

(52) U.S. Cl. CPC B25J 17/00; B25J 11/005

(57) ABSTRACT

A robot unit includes a robot body which is an arm-type robot having a plurality of arms coupled via joints, and in which one or more connecting portions are provided on a surface of at least one of the arms, and one or more auxiliary parts which are attachable and detachable to and from the arms via the connecting portions and which control or support movement of at least one of the joints.

### CROSS REFERENCE TO RELATED APPLICATION

The present application claims priority under 35 U.S.C. § 119 to Japanese Patent Application No. 2018-177807 filed on Sep. 21, 2018, including the specification, claims, drawings, and abstract, is incorporated herein by reference in its entirety.

### TECHNICAL FIELD

The present specification discloses a robot unit having a robot body which an arm-type robot is having a plurality of arms coupled via joints.

### BACKGROUND

Conventionally, an arm-type robot having a plurality of arms connected via joints has been widely known. Such an arm-type robot is, for example, placed in a factory and utilized for manufacturing products. Further, in recent years, some have proposed placing an arm-type robot, particularly, inside a machining room of a machine tool in a factory. For example, JP 2017-202548 A discloses placing an arm-type robot at a main shaft of a machine tool. Further, J P 2017-213658 A discloses placing an arm-type robot on a tool post of a machine tool, and JP 2018-020402 A discloses placing an arm-type robot at a main shaft of a tool of a machine tool.

Such an arm-type robot is used for various kinds of applications because such an arm-type robot can make various movements. Particularly, by making an end effector to be attached to the arm-type robot replaceable, it is possible to perform various kinds of work with the one arm-type robot.

Incidentally, characteristics (such as maximum torque, joint stiffness, and compactness) required for joints of an arm-type robot differ in accordance with types of work to be performed and surrounding environments. For example, when heavy goods are conveyed with an arm-type robot, the joints are required to have greater maximum torque. Meanwhile, in a case where work which requires high location accuracy of the arm-type robot is performed, the joints are required to have high stiffness. Further, when work is performed in a narrow space, the arm-type robot is required to be compact.

### SUMMARY

### Technical Problem

However, conventionally, characteristics of the joints of the arm-type robot have been fixed, and cannot be changed in accordance with work, or the like. Further, it has been difficult to simultaneously realize requirements for torque, joint stiffness, and compactness. Therefore, the present specification discloses a robot unit which can change characteristics of the joints in accordance with situations.

### Solution to Problem

A robot unit disclosed in the present specification includes a robot body which is an arm-type robot having a plurality of arms coupled via joints, and in which one or more connecting portions are provided on a surface of at least one of the arms, and one or more auxiliary parts which are attachable and detachable to and from the arms via the connecting portions and which control or support movement of at least one of the joints.

By employing such a configuration, the auxiliary parts may be attached and detached, so that characteristics of the joints may be changed. Then, as a result, it is possible to change characteristics of the joints in accordance with situations.

Further, the one or more auxiliary parts may include a locking part which locks movement of a joint between two arms by being attached to respective connecting portions of the two arms.

By employing such a configuration, stiffness of the joint may be improved as necessary.

Further, the one or more auxiliary parts may include a spring part which includes a spring element and which adds spring characteristics to movement of a joint between two arms by being attached to respective connecting portions of the two arms.

By employing such a configuration, spring characteristics may be provided to the joint as necessary.

Further, the one or more auxiliary parts may include a damper part which includes a damper element and which adds damper characteristics to movement of a joint between two adjacent arms by being attached to respective connecting portions of the two adjacent arms.

By employing such a configuration, damper characteristics may be provided to the joint as necessary.

Further, the one or more auxiliary parts may include a supporting part which includes an actuator, and which support movement of a joint which couples arms by being attached to connecting portions of the arms.

By employing such a configuration, output torque of the joint may be increased as necessary.

Further, a plurality of types of auxiliary parts which are attachable to one connecting portion may be prepared, and an auxiliary part to be attached to the one connecting portion may be replaceable.

By employing such a configuration, characteristics of the joints may be changed in a greater variety of ways.

Further, one or more end effector attaching portions to and from which an end effector is attachable and detachable may be provided at the robot body, and a plurality of types of end effectors which are attachable to one end effector attaching portion may be prepared.

By employing such a configuration, types of work which can be executed at the robot unit may be increased, so that versatility of the robot unit may be further improved.

The robot body may be placed inside a machine room of a machine tool.

By employing such a configuration, work which can be executed at the machine tool may be increased, so that productivity of the machine tool may be further improved.

According to a robot unit disclosed in the present specification, it is possible to change characteristics of joints in accordance with situations.

### BRIEF DESCRIPTION OF DRAWINGS

An embodiment of the present disclosure will be described based on the following figures, wherein:

FIG. 1 is a schematic sectional view of a machine tool in which a robot unit is incorporated;

FIG. 2 is a view illustrating the robot unit to which a locking part is attached as an auxiliary part;

FIG. 3 is a view illustrating the robot unit to which a spring part is attached as the auxiliary part;

FIG. 4 is a view illustrating the robot unit to which a damper part is attached as the auxiliary part;

FIG. 5 is a view illustrating the robot unit to which a supporting part is attached as the auxiliary part;

FIG. 6 is a view illustrating another attachment example of the auxiliary part; and

FIG. 7 is a view illustrating another attachment example of the auxiliary parts.

### DESCRIPTION OF EMBODIMENTS

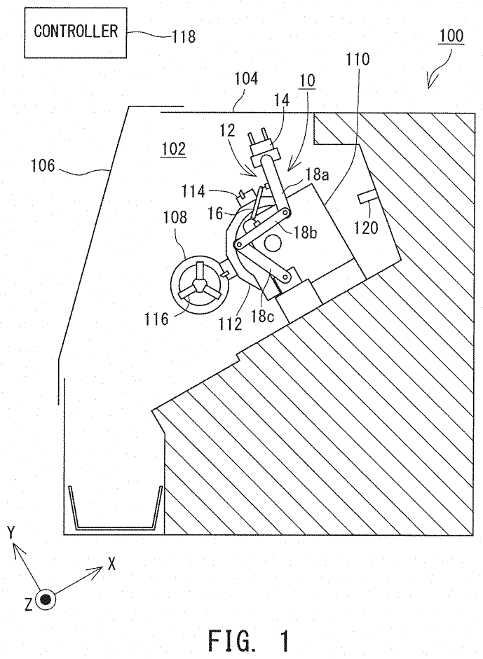

A configuration of a robot unit 10 will be described below with reference to the drawings. FIG. 1 is a schematic sectional view of a machine tool 100 in which the robot unit 10 is incorporated. Note that, in the following description, a direction parallel to a rotation axis of a main shaft 108 will be referred to as a Z axis, a direction parallel to a moving direction orthogonal to the Z axis of a tool post 110 will be referred to as an X axis, and a direction orthogonal to the X axis and the Z axis will be referred to as a Y axis.

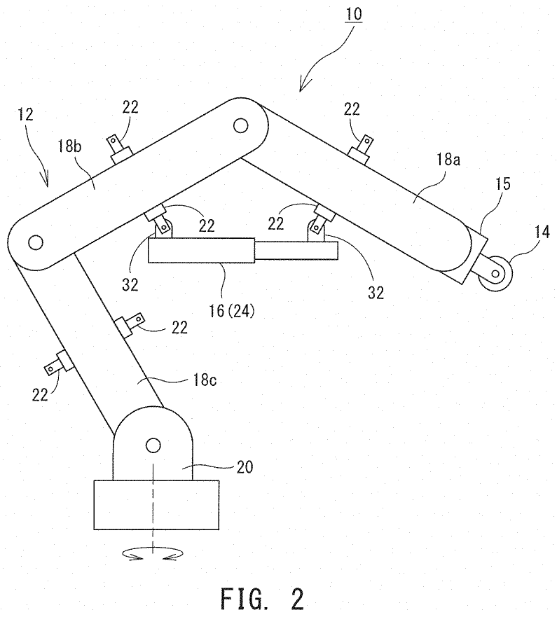

The machine tool 100 in which the robot unit 10 is incorporated will be simply described first. This machine tool 100 is a turning machine which machines a workpiece by bringing a tool 114 held at the tool post 110 into contact with a rotating workpiece (not illustrated in FIG. 1 and FIG. 2). More specifically, this machine tool 100 is a turning center which includes a turret 112 which is subjected to numerical control and which holds a plurality of tools 114.

A periphery of a machine room 102 of the machine tool 100 is covered with a cover 104. A large opening is formed on a front face of the machine room 102, and this opening is open and closed by a door 106. The machine tool 100 includes a main shaft device which holds one end of the workpiece so as to allow rotation, the tool post 110 which holds the tool 114, and a tailstock (not illustrated) which supports the other end of the workpiece. The main shaft device includes a head stock (not illustrated) which incorporates a rotating motor, or the like, and the main shaft 108 attached to the head stock. The main shaft 108 includes a chuck 116 and a collet which detachably hold the workpiece, and can replace a held workpiece as appropriate. Further, the main shaft 108 and the chuck 116 rotate around a rotation axis extending in a horizontal direction (Z axis direction).

The tailstock is disposed in the Z axis direction so as to face the main shaft 108, and supports the other end of workpiece held at the main shaft 108. The tailstock can move in the Z axis direction so as to be able to contact and be separated from the workpiece.

The tool post 110 holds the tool 114, such as a turning cut tool called a bite. This tool post 110 can move in a direction parallel to the Z axis and in a direction parallel to the X axis, and can change a position of a cutting edge of the tool 114 by movement of the tool post 110.

The turret 112 has a polygonal shape when viewed from the Z axis direction, and can rotate around an axis parallel to the Z axis. One or more tools 114 are detachably attached on a peripheral surface of this turret 112, and it is possible to change the tool 114 to be used for machining by rotating the turret 112.

A controller 118 controls driving of each unit of the machine tool 100 in response to an instruction from an operator. This controller 118 includes, for example, a CPU which performs various kinds of operation, and a memory which stores various kinds of control programs and control parameters. Further, the controller 118 has a communication function and can transmit and receive various kinds of data such as, for example, NC program data to and from other apparatuses. This controller 118 may include, for example, a numerical control device which calculates positions of the tool 114 and the workpiece as needed. Further, the controller 118 may be a single device or may be combination of a plurality of operation devices. Further, driving of the robot unit 10 which will be described later may be controlled by this controller 118 or may be controlled by a controller different from the controller 118 of the machine tool.

Inside the machine room 102, further, the robot unit 10 is provided. The robot unit 10 includes a robot body 12, an end effector 14 attached to the robot body 12, and an auxiliary part 16 attached to the robot body 12. The robot body 12 is an arm-type robot having a plurality of (three in the illustrated example) arms 18a to 18c (note that, hereinafter, the arms 18a, 18b, and 18c will be simply referred to as an “arm 18” in a case where the arms are not distinguished from each other) connected via joints. In the present example, the robot body 12 is placed on a floor surface of the machine room 102. However, the robot body 12 may, of course, be placed at other locations. For example, the robot body 12 may be placed on a side surface of the machine room 102, at the main shaft 108, or the like. Further, the robot body 12 may be placed at a mobile body which moves inside the machine room 102, such as, for example, the tool post 110, the turret 112, or the tailstock. By virtue of the robot body 12 being placed at the mobile body, it is possible to expand a range where the robot body 12 can move. Further, in a case where the robot body 12 is placed in a milling machine, a machining center, or a multi-tasking machine, the robot body 12 may be placed at a spindle head, a table on which the workpiece is to be placed, or the like.

As illustrated in FIG. 2, the robot body 12 in the present example is a vertical articulated robot having three arms 18 which can swing around the horizontal axis (which can swing within a vertical plane). A root joint 20 which can rotate around a vertical axis is provided at a root of the robot body 12. Each of the arms 18 has a hollow chassis. The chassis is formed from, for example, a metal (such as aluminum). Inside this chassis of the arm 18, an actuator (such as a motor), a transmission mechanism (such as a gear), and a sensor (such as a rotary encoder) are incorporated. Then, the arm 18 swings by the built-in actuator being driven, and the swing amount is detected by the built-in sensor. Further, inside the chassis of the arm 18, wirings for transmitting and receiving various kinds of signals and power are housed.

On an outer surface of each arm 18, a connecting portion 22 to and from which an auxiliary part 16 which will be described later is attachable and detachable is provided. The number of connecting portions 22 is not particularly limited if the auxiliary part 16 is attachable and detachable to and from the connecting portions 22. Note that a configuration of this connecting portion 22 will be described later.

An end effector 14 is provided at the robot body 12. The end effector 14 accesses an object and exerts some kinds of action. Here, “access” means bringing the end effector 14 closer to the object to a position where purpose of the end effector 14 can be achieved. Therefore, in a case where the end effector 14 is a temperature sensor which detects a temperature by contact, “access” means that the end effector 14 contacts the object. Further, in a case where the end effector 14 is a temperature sensor which detects a temperature in a non-contact manner, “access” means that the end effector 14 approaches the object to a position where the end effector 14 can detect a temperature of the object.

One or a plurality of end effectors 14 may be attached to one robot body 12. Further, the end effector 14 may be attached to a tip of the robot body 12 or may be attached in the middle of the robot body 12. In the present example, one end effector 14 is attached to the tip of the robot body 12.

Further, as described above, the end effector 14 is not particularly limited if the end effector 14 exerts some kinds of action. Therefore, the end effector 14 may be, for example, a holding device (such as a hand mechanism or a sucking and holding mechanism) which holds an object. Further, as another form, the end effector 14 may be, for example, a sensor (such as a temperature sensor, a vibration sensor, a tactile sensor, or a pressure sensor) which senses information regarding an object and an environment around an object, or as still another form, the end effector 14 may be, for example, a pressing mechanism which presses an object. For example, the end effector 14 may be a roller, or the like, which suppresses vibration by pressing the work while allowing rotation of the workpiece. Further, as another form, the end effector 14 may be a device which outputs a fluid (such as air, cutting oil, or cutting water) for assisting machining. Further, the end effector 14 may be a device which emits energy (such as laser or arc) or a material (for example, a material for additive fabrication) for work fabrication. As a still another form, the end effector 14 may be a camera which photographs an object.

Such an end effector 14 may be detachable from the robot body 12, and types of the end effector 14 may be replaceable in accordance with situations. That is, the robot body 12 may include one or more end effector attaching portions 15, and a plurality of types of end effectors 14 which can be attached to one end effector attaching portion 15 may be prepared. For example, before machining of a workpiece is started, the end effector 14 having a hand mechanism is attached to the robot body 12, and the workpiece is conveyed by utilizing the hand mechanism. Then, after the workpiece is conveyed, the end effector 14 may be replaced with the end effector 14 which is a temperature sensor, and temperatures of the workpiece which is being machined and a tool may be sensed. By employing such a configuration, it is possible to improve versatility of the robot unit 10. Note that, of course, the end effector 14 may be undetachably attached to the robot body 12. Note that, in the illustrated example, one end effector 14 is provided at a tip of the robot body 12. However, the number of end effectors 14 to be attached to one robot body 12 is not limited, and one or a plurality of end effectors 14 may be attached. Further, a position where the end effector 14 is attached may be a tip of the robot body 12 or an intermediate position of the robot body 12.

The robot unit 10 further includes the auxiliary part 16 which controls or supports movement of the joints of the robot body 12. The auxiliary part 16 can be attached to and detached from the robot body 12 via the above-described connecting portions 22. The reason why such an auxiliary part 16 is provided will be described simply.

As described above, the robot body 12 in the present example is placed inside the machine room 102 of the machine tool 100. Characteristics required for the joints of such a robot body 12 are changed in accordance with work to be executed by the robot body 12 and an environment around the robot body 12. For example, when heavy goods are conveyed, it is preferable that the joints of the robot body 12 can output large torque. Further, to improve machining accuracy, there is a case where vibration of the workpiece is suppressed by the end effector 14 which is a roller being pressed against the rotating held workpiece. In such a case, there is a case where the joints of the robot body 12 are required to have high stiffness. Meanwhile, there is also a case where it is desired to maintain substantially constant pressing force of the roller, in which case spring characteristics are required. Particularly, in a case where high responsiveness is required, not spring characteristics using a servo, but mechanical spring characteristics are required. Further, in a case where the robot body 12 is required to have high instantaneousness, it is desired that the joints of the robot body 12 have moderate spring characteristics in a similar manner to joints of a human. Further, under an environment where a relatively large object is likely to collide with the robot body 12, in a case where the joints of the robot body 12 are stiff, there is a possibility that collision load cannot be absorbed, and the joints may be damaged. Therefore, under such an environment, the joints of the robot body 12 may have moderate spring characteristics or attenuation characteristics. Further, in a case where the robot is located in an environment where there is vibration by the machine tool, there is a case where moderate attenuation characteristics are required so that the robot does not vibrate.

However, normally, characteristics of the joints of the robot body 12 are fixed, and the characteristics of the joints cannot be changed in accordance with work and surrounding environments. Therefore, normally, work which can be favorably executed by one robot body 12 and a surrounding environment in which one robot body 12 can favorably execute work are limited, which results in limited versatility of the robot body 12. Particularly, in recent years, to improve versatility of the robot body 12, it has been proposed to make the end effector 14 replaceable. However, in a case where the characteristics of the joints are fixed, versatility of the robot body 12 cannot be sufficiently improved.

Therefore, in the present example, a plurality of types of auxiliary parts 16 which are attachable and detachable to and from the arm 18 are prepared, so that the auxiliary part 16 to be attached to the arm 18 can be replaced in accordance with situations. By this means, it is possible to change the characteristics of the joints of the robot body 12 in accordance with situations. Then, as a result, it is possible to further improve versatility of the robot body 12. This auxiliary part 16 will be described in detail below.

The auxiliary part 16 is a part which is detachably attached to one or more arms 18 in order to control or support movement of the joints. Specifically, the auxiliary part 16 may be a locking part 24 which locks movement of a joint between two arms 18 by being attached to respective connecting portions 22 of the two arms 18. FIG. 2 is a view illustrating an aspect where the auxiliary part 16 which is the locking part 24 is attached to the robot body 12. The locking part 24 is, for example, a bar whose size in a longitudinal direction can be fixed, can fix an interval between two connecting portions 22 by being attached to the respective connecting portions 22 of the two arms 18, and, eventually, fixes movement of the joint between the two connecting portions 22. While the size of such a locking part 24 in the longitudinal direction may be unchangeable, if the size can be fixed as necessary, the size may be changeable. If the size of the locking part 24 in the longitudinal direction is changeable, it is possible to lock the robot body 12 in various attitudes with one locking part 24.

While various structures are possible as a structure of the locking part 24 whose size is changeable, for example, the locking part 24 may be configured by combining a cylindrical body and a bar which can proceed and recede inside the cylindrical body. In this case, it is also possible to form a female screw on an inner surface of the cylindrical body and form a male screw which is screwed into the female screw on an outer periphery surface of the bar. Further, it is also possible to configure the bar so as to be able to slide with respect to the cylindrical body and provide a locking mechanism which locks sliding with a desired progression amount. Further, as another form, the locking part 24 may be configured by coupling a plurality of tops. Then, it is also possible to adjust the size of the locking part 24 in the longitudinal direction by changing the number of tops to be coupled as appropriate. It is possible to use the robot as a different type of robot by locking part of the joints. For example, it is possible to realize a configuration which is the same as a configuration of a triaxial SCARA robot by locking three joints of a hexaxial articulated robot. By this configuration, torque is not applied in a rotation direction of the joints, enabling conveyance of heavy goods.

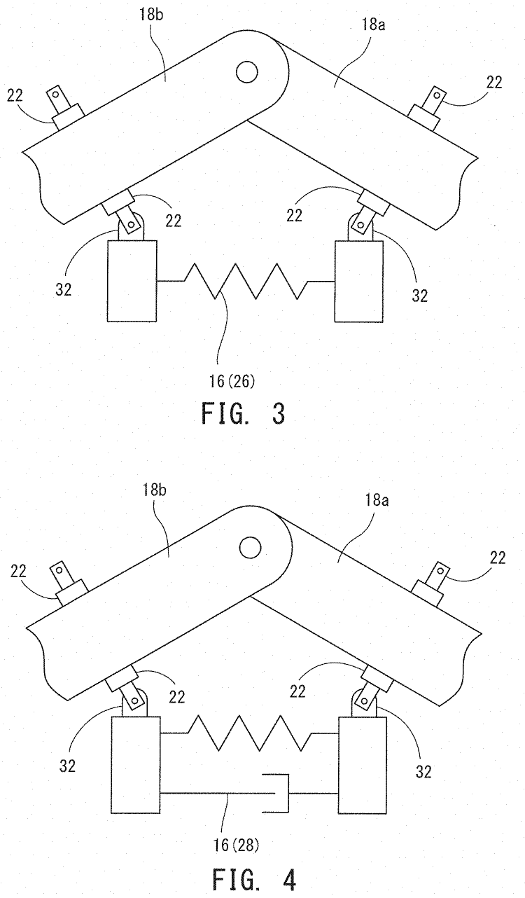

Further, the auxiliary part 16 may be the spring part 26 including a spring element. FIG. 3 is a view illustrating aspect where the auxiliary part 16 which is the spring part 26 is attached to the robot body 12. By such an auxiliary part 16 (spring part 26) being attached to respective connecting portions 22 of two arms 18, spring characteristics are provided to movement of the joint between the two arms 18. As a result, it is possible to provide moderate shock absorption and instantaneousness to the robot body 12, and it is also possible to provide moderate softness to hands.

Further, the auxiliary part 16 may be the damper part 28 including a damper element. FIG. 4 is a view illustrating an aspect where the auxiliary part 16 which is the damper part 28 is attached to the robot body 12. By attachment of such an auxiliary part 16 (damper part 28) to respective connecting portions 22 of two arms 18, attenuation characteristics are provided to movement of a joint between the two arms 18. As a result, it is possible to further improve vibration resistance and shock absorption of the robot body 12.

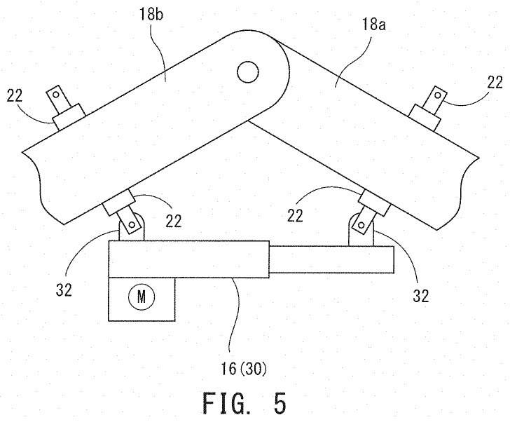

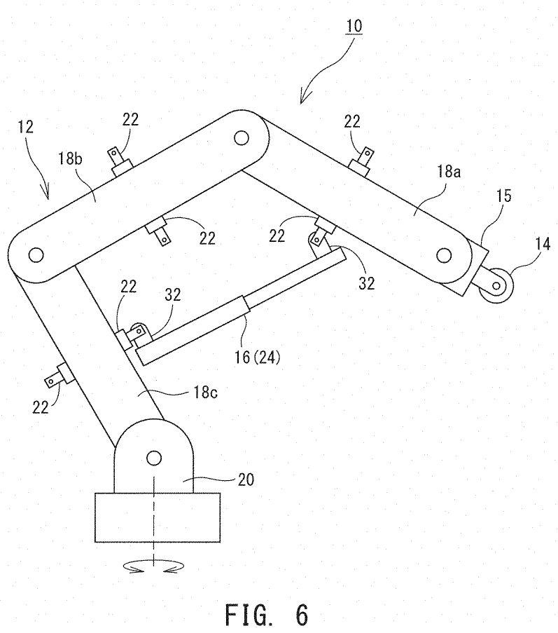

Further, the auxiliary part 16 may include the supporting part 30 including an actuator. FIG. 5 is a view illustrating an aspect where the auxiliary part 16 which is the supporting part 30 is attached to the robot body 12. By attachment of such an auxiliary part 16 (supporting part 30) to connecting portions 22 of the arms 18, movement of a joint which couples the arms 18 is supported. Then, by this means, it is possible to temporarily improve output torque of the robot body 12. Note that, as the actuator, an electric motor, a solenoid actuator, or a power cylinder (such as a hydraulic cylinder or a pneumatic cylinder) can be used. Further, an energy source of the actuator may be incorporated into the auxiliary part 16. By employing such a configuration, it is possible to simplify wirings. For example, in a case where an electric actuator (such as an electric motor or a solenoid) is used as an actuator, in addition to the electric actuator, a battery may be incorporated into the auxiliary part 16. Further, while a drive signal of the actuator may be transmitted in a wired manner, the drive signal may also be transmitted in a wireless manner. By employing such a configuration, it is possible to further simplify wirings.

Note that, in the above description, one auxiliary part 16 is attached to two adjacent arms 18. However, as illustrated in FIG. 6, the auxiliary part 16 may be attached to two arms 18a and 18c separated from each other across one or more arms 18. In FIG. 6, the auxiliary part 16 which is the locking part 24 is attached to the first arm 18a and the third arm 18c. Also in this case, movement of a joint between the first arm 18a and the second arm 18b and movement of a joint between the second arm 18b and the third arm 18c are locked.

Further, in a case where the supporting part 30 is used as the auxiliary part 16, because it is only necessary that the auxiliary part 16 can transmit torque to the arm 18, the auxiliary part 16 does not necessarily have to be attached to two arms 18. For example, it is also possible to employ a configuration where one end of the auxiliary part 16 (supporting part 30) is attached to a connecting portion 22 of one arm 18, and the other end only abuts on the other arm 18.

Incidentally, to attach and detach such an auxiliary part 16 to and from the arm 18, the connecting portions 22 are provided on a surface of the arm 18, and connected portions 32 which are to be connected to the connecting portions 22 are provided at the auxiliary part 16. Configurations of the connecting portion 22 and the connected portion 32 are not particularly limited, so long as the connecting portion 22 and the connected portion 32 are attachable and detachable to and from each other. Therefore, one of the connecting portion 22 and the connected portion 32 may be a female screw, and the other may be a male screw which can be screwed into the female screw. Further, as another form, the connecting portion 22 and the connected portion 32 may have structures of various kinds of dampers and fittings. Further, as still another form, one of the connecting portion 22 and the connected portion 32 may be an annular body whose part can be open and closed, such as a swivel or a shackle, and the other may be another annular body which is linked with the annular body.

Further, a relative angle of the auxiliary part 16 and the arm 18 changes in accordance with attitudes of each arm 18. To absorb this angular change, at least one of the connecting portion 22 and the connected portion 32 may have some kind of swing structure. For example, at least one of the connecting portion 22 and the connected portion 32 may have a hinge structure, a universal joint structure, or the like. By employing such a swing structure, even if the arm 18 swings, it is possible to maintain attachment relationship between the auxiliary part 16 and the arm 18.

A plurality of types of the auxiliary part 16 as described above may be prepared for one robot body 12. Then, the auxiliary part 16 which is selected in accordance with work to be performed by the robot body 12 and surrounding environments may be attached to the robot body 12. By employing such a configuration, because it is possible to change characteristics of joints of the robot body 12 in accordance with work and surrounding environments, it is possible to further improve versatility of the robot body 12.

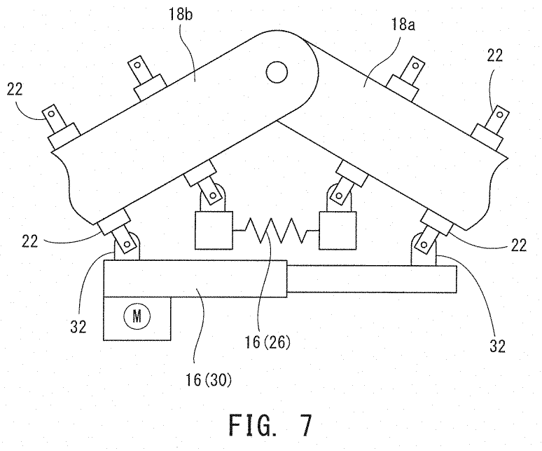

Note that one or a plurality of auxiliary pats 16 may be attached to one robot body 12. Further, two or more different types of auxiliary parts 16 may be attached to the same arm 18. For example, as illustrated in FIG. 7, the auxiliary part 16 which is the damper part 28 and the auxiliary part 16 which is the supporting part 30 may be attached to one arm 18.

Further, such an auxiliary part 16 may be manually attached and detached by a worker or may be automatically attached and detached by machine. For example, it is also possible to provide two or more robot units 10 inside the machine room 102, and attach and detach the auxiliary part 16 of one robot unit 10 using another robot unit 10. By automatic attachment and detachment of the auxiliary part 16, even two or more types of work which require different joint characteristics can be successively executed with one robot unit 10.

Further, while, in the above description, description has been provided assuming that the robot body 12 is a vertical articulated robot, the technology of the present example may be applied to arm-type robots having other forms. Therefore, the robot body 12 may be, for example, a SCARA robot having an arm 18 which swings around a vertical axis (swing within a horizontal plane) and a tip arm 18 which can proceed and recede in a vertical axis direction.

Further, the robot unit 10 may be provided at other locations as well as in a machine room 102 of the machine tool 100. For example, the robot unit 10 may be incorporated into other equipment or may be independently placed without being incorporated into other equipment. For example, the robot unit 10 may be independently placed in the middle of a production line. Further, the robot unit 10 may be placed in an outdoor environment.

### REFERENCE SIGNS LIST

10 robot unit
12 robot body
14 end effector
15 end effector attaching portion
16 auxiliary part
18 arm
20 root joint
22 connecting portion
24 locking part
26 spring part
28 damper part
30 supporting part
32 connected portion
100 machine tool
102 machine room
104 cover
106 door
108 main shaft
110 tool post
112 turret
114 tool
116 chuck
118 controller

1. A robot unit comprising:
a robot body which is an arm-type robot having a plurality of arms coupled via joints, and in which one or more connecting portions are provided on a surface of at least one of the arms; and
one or more auxiliary parts which are attachable and detachable to and from the arms via the connecting portions and which control or support movement of at least one of the joints.

2. The robot unit according to claim 1,
wherein the one or more auxiliary parts include a locking part which locks movement of a joint between two arms by being attached to respective connecting portions of the two arms.

3. The robot unit according to claim 1,
wherein the one or more auxiliary parts include a spring part which includes a spring element and adds spring characteristics to movement of a joint between two arms by being attached to respective connecting portions of the two arms.

4. The robot unit according to claim 1,
wherein the one or more auxiliary parts include a damper part which includes a damper element and which adds damper characteristics to movement of a joint between two adjacent arms by being attached to respective connecting portions of the two adjacent arms.

5. The robot unit according to claim 1,
wherein the one or more auxiliary parts include a supporting part which includes an actuator, and which supports movement of the joint which couples arms by being attached to connecting portions of the arms.

6. The robot unit according to claim 1,
wherein a plurality of types of auxiliary parts which are attachable to one connecting portion are prepared, and
an auxiliary part to be attached to the one connecting portion is replaceable.

7. The robot unit according to claim 1,
wherein one or more end effector attaching portions to and from which an end effector is attachable and detachable are provided at the robot body, and
a plurality of types of end effectors which are attachable to one end effector attaching portion are prepared.

8. The robot unit according to claim 1,
wherein the robot body is placed inside a machine room of a machine tool.
